(19) United States
(12) Patent Application Publication
(10) Pub. No.: US 2017/0114554 A1
(43) Pub. Date: Apr. 27, 2017

(54) HIDDEN DECK FASTENER INSTALLATION ATTACHMENT AND FASTENER LOADING DEVICE

(71) Applicant: Pan American Screw LLC, Conover, NC (US)

(72) Inventor: Kenneth LeVey, Chicago, IL (US)

(21) Appl. No.: 15/296,769

(22) Filed: Oct. 18, 2016

Related U.S. Application Data
(60) Provisional application No. 62/245,067, filed on Oct. 22, 2015.

(51) Int. Cl. E04F 21/22; B25C 7/00

(52) U.S. Cl. CPC E04F 21/22; B25C 7/00; E04F 15/02044

(57) ABSTRACT

An attachment is configured to mounting to a drive tool for securing hidden deck clips in a substrate. The clips have a slit and bent body that forms a pair of forward base flanges and a rearward base flange and a forward groove flange formed from an upturned leg and groove leg between, above and spaced from the forward base flanges. The attachment includes a body, and a pair of legs defining a receiving region between the legs and between the substrate and body. The body includes a top surface, a clip abutment surface and at least one magnetic element on the abutment surface for temporarily securing the hidden deck clip to the body. A loader for loading deck clips into the attachment is also disclosed.

CROSS-REFERENCE TO RELATED APPLICATION DATA

This application claims the benefit of and priority to Provisional U.S. Patent Application Ser. No. 62/245,067, filed Oct. 22, 2015, the disclosure of which is incorporated herein in its entirety.

### BACKGROUND

The present disclosure relates to a device for loading and installing decking fasteners. Composite and wood decking is typically installed by securing the individual deck boards to a framework of, for example, wood or steel. One known way in which the deck boards are secured includes driving fasteners such as screw or nails directly through the boards into an underlying structure. While this may function well to secure the boards, it is not an aesthetically pleasing arrangement.

One aesthetically acceptable way to secure the boards is to use adhesives to glue the boards to the underlying structure. Again, this method functions well to secure the deck boards. However, such adhesives require time to cure and harden. As such, there is always the chance that boards will slip out of place before the adhesive has had sufficient time to cure. To alleviate this, fasteners are needed to temporarily secure the boards in place until the adhesive has had sufficient time to cure. This method increases the labor, materials and costs for installation and may require the use of special tools to install the fasteners.

Another aesthetically acceptable way to secure the boards is to drive fasteners through edges or grooves of the board, at an angle, into the underlying structure. In such an installation, the fasteners are hidden from view, and deck boards can be fitted to one another in a tongue and groove installation.

Still another way to secure the boards is the use of specialty deck fasteners that are positioned in the grooves of adjacent boards. In this arrangement, the boards are manufactured with edge grooves on both sides into which the deck fasteners fit. The deck fasteners are secured to the underlying structure, such as with fasteners, such as screws, between the boards or as one board is installed such that an adjacent board is then fitted under the deck fastener. One type of deck fastener is a MANTIS® hidden deck fastener, commercially available from Deerwood Fasteners, a division of Pan American Screw LLC, of Conover, N.C. An example of a MANTIS® hidden deck fastener is illustrated in FIG. 1. The fasteners are typically installed using powered drivers, such as a powered screw gun to install the deck fasteners to the underlying structure.

While the use of such deck fasteners is clearly a superior method to secure deck boards due to the aesthetics of this installation method, the clips must be loaded into the screw gun and secured in place (between the tip of the gun and the board) as the fastener is driven through the deck fastener. One known device for securing and holding the deck fastener is a slide that installs onto the driver tool or screw gun. The slide is positioned adjacent to the board and the deck fastener is inserted into the slide. The gun and deck fastener are then slid along the slide until the deck fastener is in position (in the deck board groove) and the screw gun is actuated.

Accordingly, there is a need for an attachment for a driver tool, e.g., screw gun, on which a deck fastener is held during installation. Desirably, such an attachment temporarily holds the deck fastener and releases the fastener by action of the fastener (e.g., the screw) being driven through deck fastener and into the substrate. More desirably still, such an attachment is readily loaded with deck fasteners without having to manipulate the individual deck fasteners and positioning the deck fasteners on the attachment.

### SUMMARY

Various embodiments of the present disclosure provide an attachment for a drive tool for securing hidden deck clips in a substrate and a loader for loading the clips into the attachment. The attachment is used with a powered drive tool, such as a screw gun and with deck clips of the type that have a body that is slit and bent to form a pair of forward base flanges and a rearward base flange and a forward groove flange formed from an upturned leg and groove leg between, above and spaced from the forward base flanges. The deck clip includes an opening between the rearward base flange and the forward groove flanges for receipt of a fastener, such as a screw, to secure the clip to the substrate.

The attachment includes a body, a pair of legs defining a receiving region between the legs and between the substrate and body. The body includes a top surface and a clip abutment surface. At least one magnetic element on the abutment surface temporarily secures the hidden deck clip to the body.

In an embodiment, the magnet is disposed in a bore in the body and an end of the magnet lies about flush with the abutment surface. In an embodiment, two magnets are disposed in bores in the body, the ends of the magnets lying about flush with the abutment surface.

The legs can extend above and below the body and forward of the clip abutment surface to center the clip on the attachment. The attachment can include a mounting region for mounting the attachment to the drive tool.

The clip loader is used to load the deck clips to the tool attachment. The loader includes a clip magazine configured to store a plurality of clips, for example, in a stack. The magazine defines a discharge end opening from which clips are discharged to the attachment and a loading end opposite the discharge end for loading clips into the loader. A restraining finger extends over and is spaced from a portion of the discharge end opening. A biased plunger in the loading end engages the plurality of clips and bias the clips toward the discharge end opening. The plunger can be biased by a spring, such as a constant force spring.

The loader can include a slide having a base surface and a pair of guide walls. The slide is positioned at the discharge end of the magazine and has an opening that cooperates with the magazine discharge end opening. Entrance and exit ramps can be positioned at either side of the opening. The restraining finger can form the entrance ramp.

These and other features and advantages of the present disclosure will be apparent from the following detailed description, in conjunction with the appended claims.

### BRIEF DESCRIPTION OF THE DRAWINGS

FIG. 1 illustrates an example of a fastener driver, or tool, shown with an embodiment of a hidden deck fastener installation attachment, and a hidden deck fastener or clip positioned on the attachment;

FIG. 2 is an enlarged view of the tool nosepiece, attachment and clip of FIG. 1;

FIG. 3 shows the tool, attachment and clip of FIGS. 1 and 2, as positioned on a substrate and being positioned to install the clip;

FIG. 4 is a figure similar to FIG. 3 shown with the tool, attachment and clip in place for installation of the clip;

FIG. 5 illustrates the attachment and a clip in position in front of the attachment and ready for receipt in the attachment;

FIG. 6 is a view similar to FIG. 5, showing the magnets in an exploded view;

FIG. 7 is an illustration of the attachment;

FIG. 8 illustrates the attachment with a clip positioned on the attachment;

FIG. 9 is a bottom view of the attachment and clip, showing the rearward base flange positioned in the attachment receiving region;

FIG. 10 illustrates an embodiment of the attachment mounted to the tool nosepiece by shoulder bolts;

FIG. 11 is a perspective view of an embodiment of a loader for loading clips into the attachment;

FIG. 12 is an illustration of the loader showing the sleeve or magazine with portions shown ghosted to illustrate the clips stacked in the magazine;

FIG. 13 is a perspective view of the loader shown partially broken away and illustrating the clip stack;

FIG. 14 is an enlarged view of the loader showing a clip in the feed position engaged with the restraining finger and the tool (and attachment) as it is positioned on the loader for engaging and receiving a clip;

FIG. 15 is an enlarged view with a wall of the loader removed for clarity of illustration, showing the attachment as it approaches a clip in the loader;

FIG. 16 is a view similar to FIG. 15 showing the attachment engaging the clip; and

FIG. 17 is a view similar to FIG. 16 showing the tool having engaged the clip, and the clip in the attachment as the clip is removed from the magazine.

### DETAILED DESCRIPTION

While the present disclosure is susceptible of embodiments in various forms, there is shown in the drawings and will hereinafter be described a presently preferred embodiment with the understanding that the present disclosure is to be considered an exemplification and is not intended to limit the disclosure to the specific embodiment illustrated.

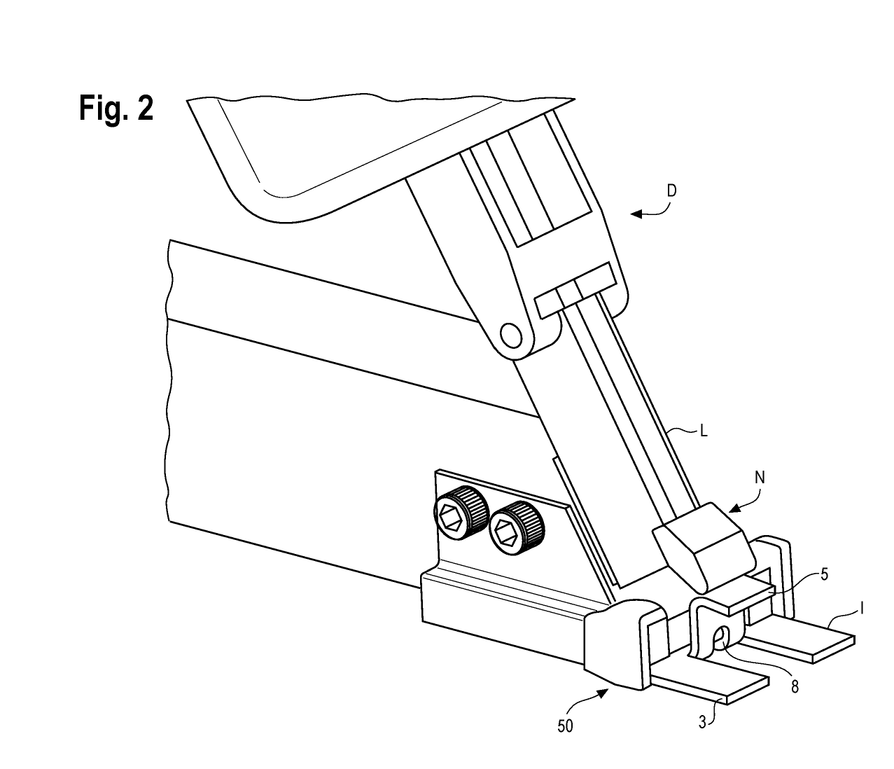

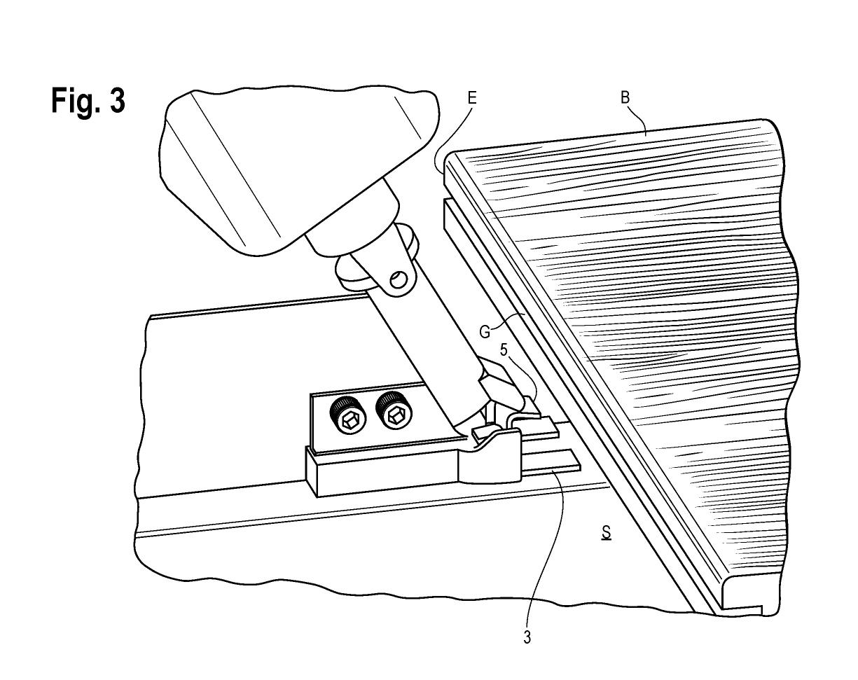

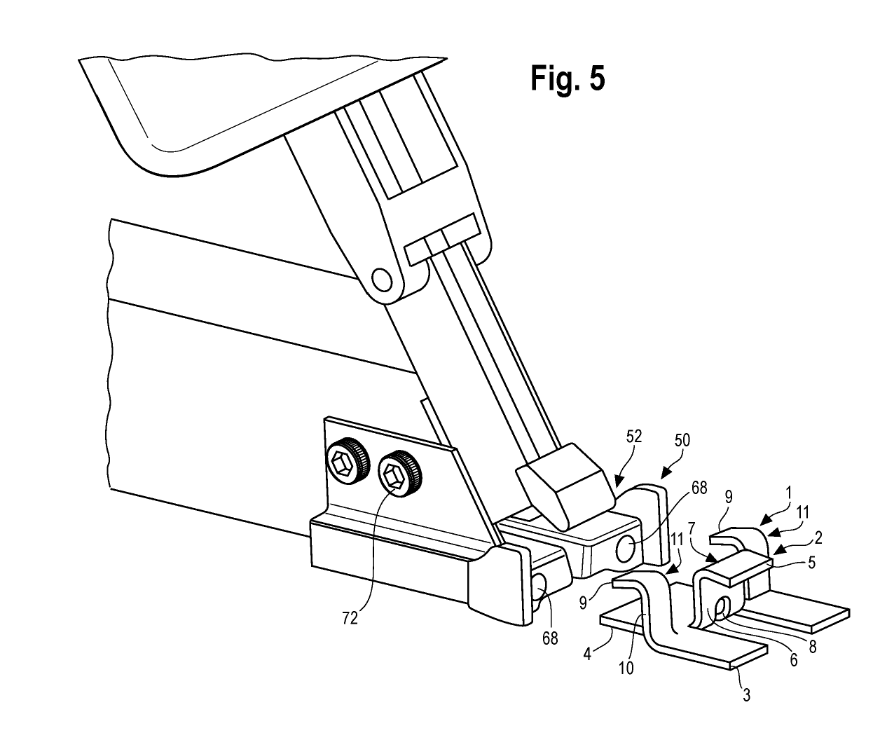

Referring now to the figures and in particular to FIGS. 2 and 3 there is illustrated an embodiment of a hidden deck fastener installation attachment 50 shown with a hidden deck fastener 1. The illustrated hidden deck fastener 1, which is best seen in FIGS. 5 and 6, is a MANTIS brand hidden deck fastener. For purposes of the present disclosure, the hidden deck fastener 1 will be referred to as a “hidden deck clip” or “deck clip”. Those skilled in the art will understand that the deck clip 1 is used to secure deck boards B to an underlying substrate S. The clip 1 includes a body 2 that is slit or cut and bent to form a number of flanges. A pair of forward base flanges 3 and a rearward base flange 4 are configured to lie flat on the underlying substrate S. The body 2 includes a forward groove flange 5 formed from an upturned leg 6 and groove leg 7 between, above and spaced from the forward base flanges 3. When viewed from the side, the clip 1 has a double “C” shape (a “C” shape and a backward “C” shape with a shared spine) with elongated lower legs. An opening 8 between the rearward base flange 4 and the forward groove flange 5 provides the space 8 through which a fastener, such as a screw (not shown), is received to secure the clip 1 to the underlying structure S.

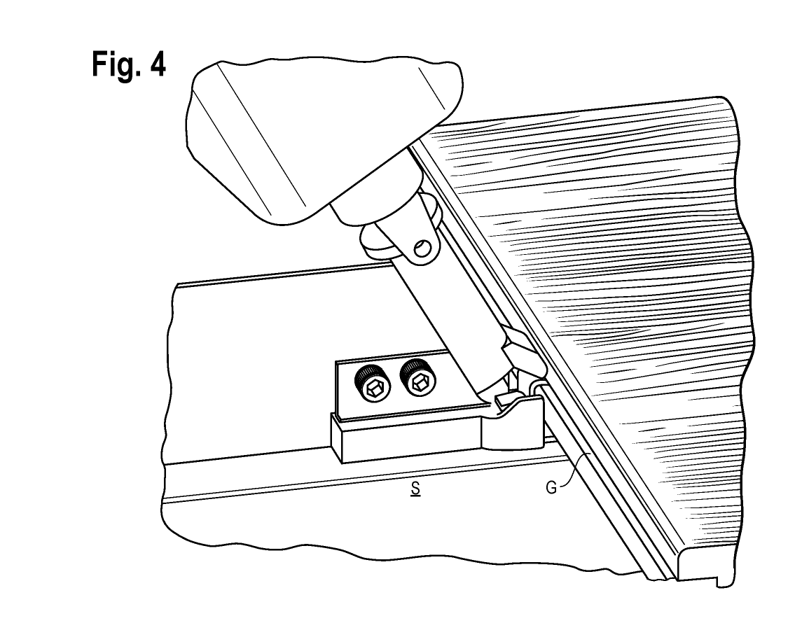

The deck clip body 2 includes a pair of rearward groove flanges 9, formed from upturned legs 10 and rearward groove legs 11 between, above and spaced from the rearward base flange 4. The groove flanges 5, 9 are at about the same distance from their respective base flanges 3, 4. As seen in FIGS. 3 and 4, She groove flanges 5, 9 are configured for receipt in grooves G in deck boards B to secure the deck board B to the underlying structure S. Those skilled in the art will recognize the types of deck boards B with which the deck clip 1 is used, as the types that include grooves G formed in both edges E of the board B. The spacing between the base flanges and the groove flanges is such as to accommodate a board having the groove formed at a specific distance from the lower surface of the board (about the same spacing as between the base and groove flanges).

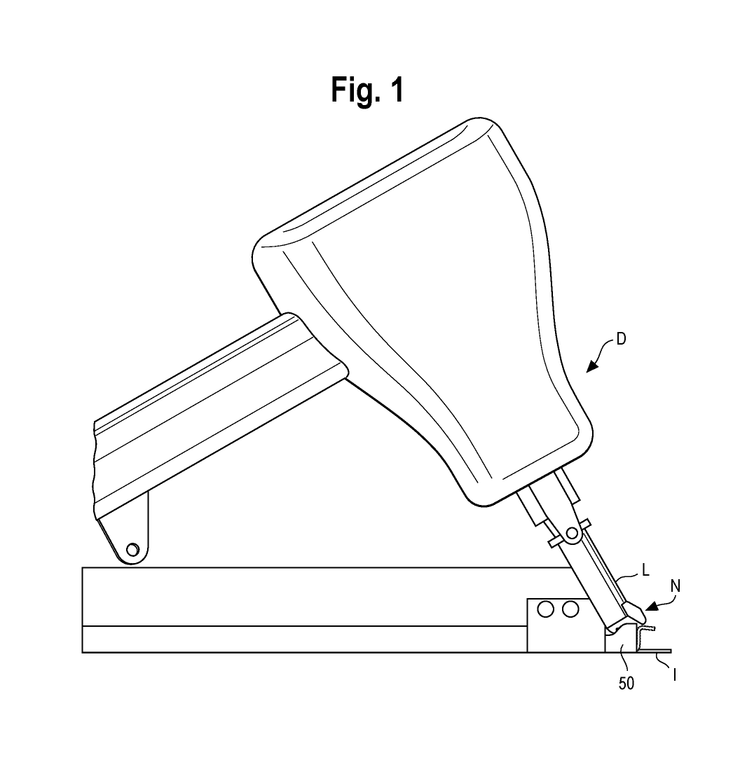

The clip fastener installation attachment 50 is configured for use with a fastener (e.g., screw) driver D, and in particular with a powered drive tool. An example of one such drive tool D is schematically illustrated in FIG. 1, and an enlarged drive tip or nosepiece N is illustrated in FIG. 2. A typical nosepiece N includes a sleeve L through which the screw is driven. A ram (not shown) internal to the sleeve L engages and moves forward and rotationally to drive the screw from the sleeve L, through the clip 1 and into the substrate S. Typically, the screw is driven at about a 45 degree angle from the tool D, into the substrate S.

The attachment 50 is configured for mounting to the nosepiece N. The attachment 50 is positioned below the sleeve L and is adapted to temporarily secure the deck clip 1 to the attachment 50 as the screw is driven through the clip 1 and into the substrate S. The attachment 50 includes a body 52 having a top surface 54, a clip abutment surface 56 adjacent and transverse to the top surface 54 and a bottom surface 58 adjacent to the clip abutment surface 56. Referring briefly to FIG. 9, in an embodiment, a pair of legs 60 are formed on sides 62 of the body 52, that rest on the substrate S and define a receiving or relieved region 64 between the legs 60, along the bottom surface 58 of the body 52 and between the substrate S and body 52. The receiving region 64 is elevated from the base 66 of the legs 60 such that the clip rearward base flange 4 is received in the receiving region 64 and so that the base flanges 3, 4 and attachment legs 60 rest on the substrate S surface when the tool D is in use.

In an embodiment, the legs 60 also extend forward of the abutment surface 56 to center the clip 1 in the attachment 50. The attachment 50 includes at least one magnetic element 68 on the abutment surface 56. As seen in FIGS. 5 and 6, multiple magnetic elements 68 can be positioned on the abutment surface 56. One way in which to provide the magnetic elements 68 is to form bores 70 in the abutment surface 56 (into the body 52) and position the magnetic elements or magnets 68 in the bores 70.

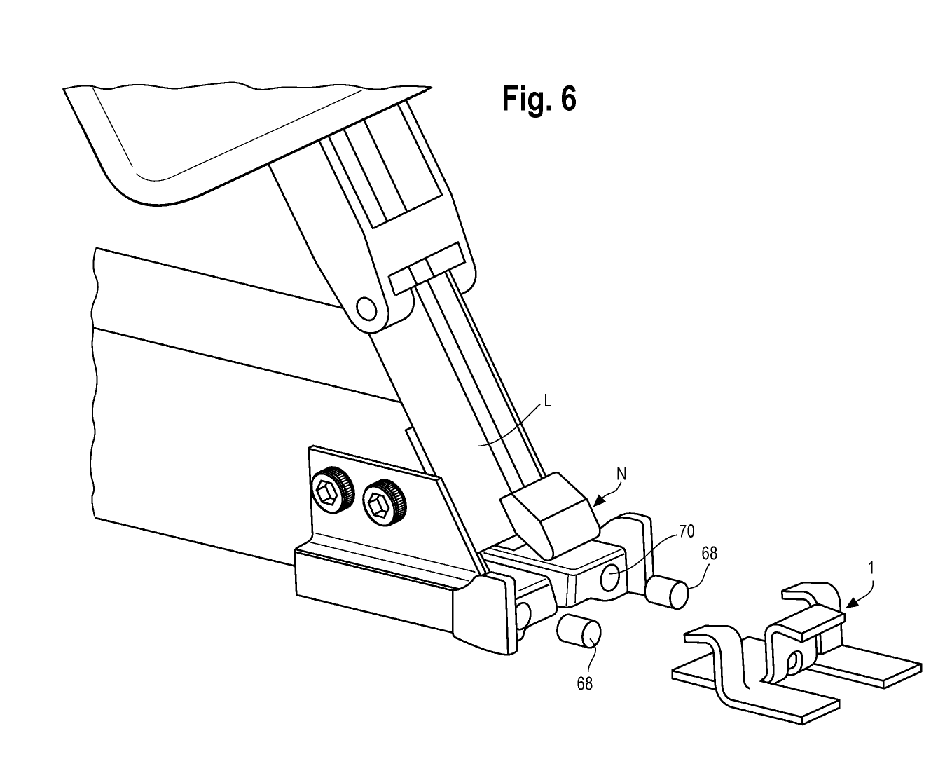

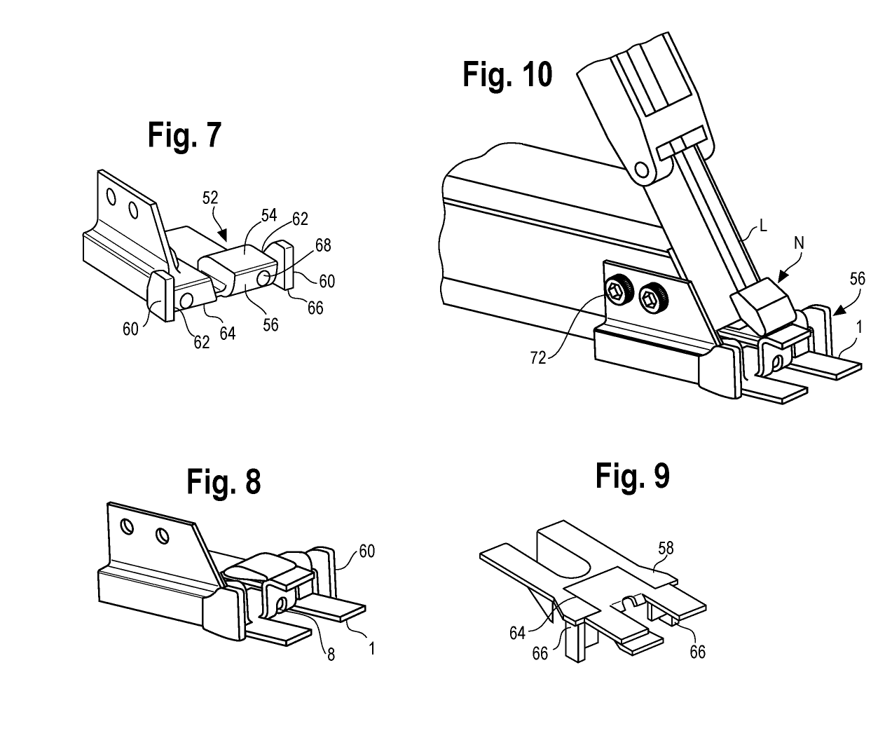

In such an arrangement, when the clip 1 is positioned in the attachment 50 with the rearward base flange 4 positioned in the receiving region 64, the rearward groove flange 9 positioned on the attachment top surface 54 and the upturned legs 10 positioned on the abutment surface 56, the magnets 68 temporarily hold the clip 1 (at the upturned legs 10) in place (see, for example, FIGS. 7-10). When the screw is driven from the tool D through the opening 8 in the clip 1 and into the substrate S, the clip 1 is secured to the board B and the substrate S. When the tool D is “pulled” away from the deck board B and clip 1, the attachment 50 is easily removed from the clip 1 as only a minor force is required to separate the magnets 68 from the clip 1.

Essentially, the attachment 50 captures the clip 1, with the attachment 50 positioned between three surfaces of the clip 1 (the rearward base and groove flanges 4 and 9 and the upturned legs 10) and secured to the attachment 50 by the magnets 68.

The attachment 50 can be mounted to the drive tool D in a variety of ways. As seen in FIGS. 6-10, the attachment 50 can be fastened to the tool D by fasteners 72 such as bolts, screws or the like. Alternatively, the attachment 50 can be formed as a part of the tool D and/or nosepiece N. All such mounting and tool configurations are within the scope and spirit of the present disclosure.

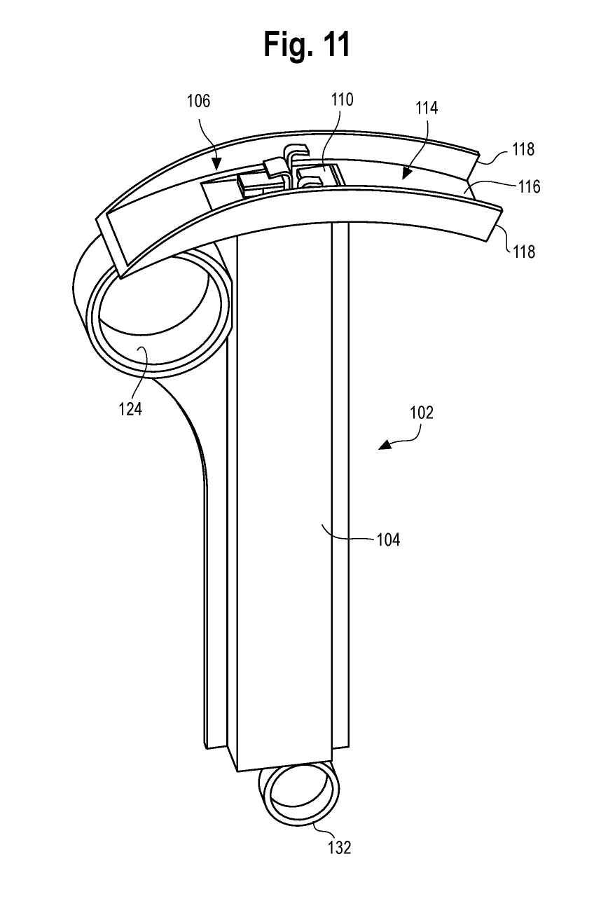

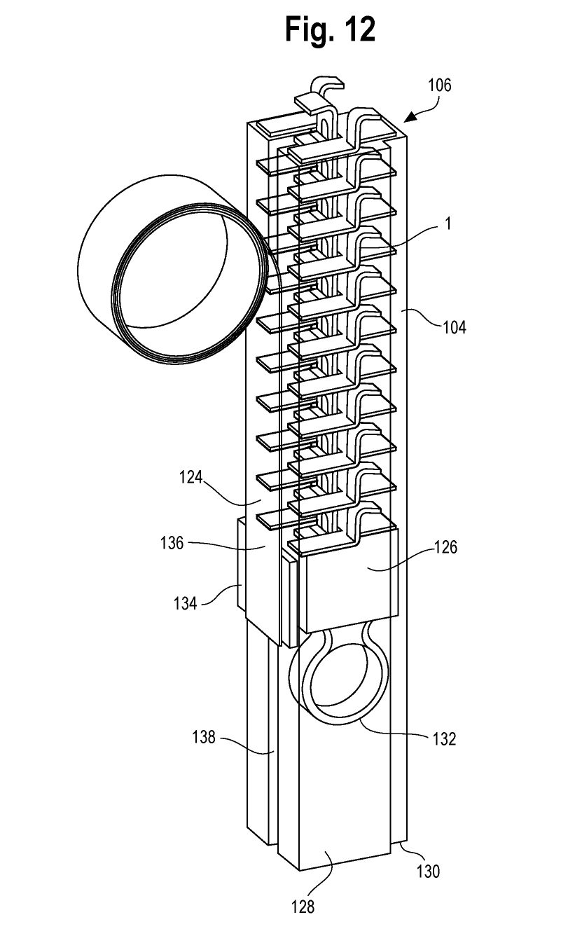

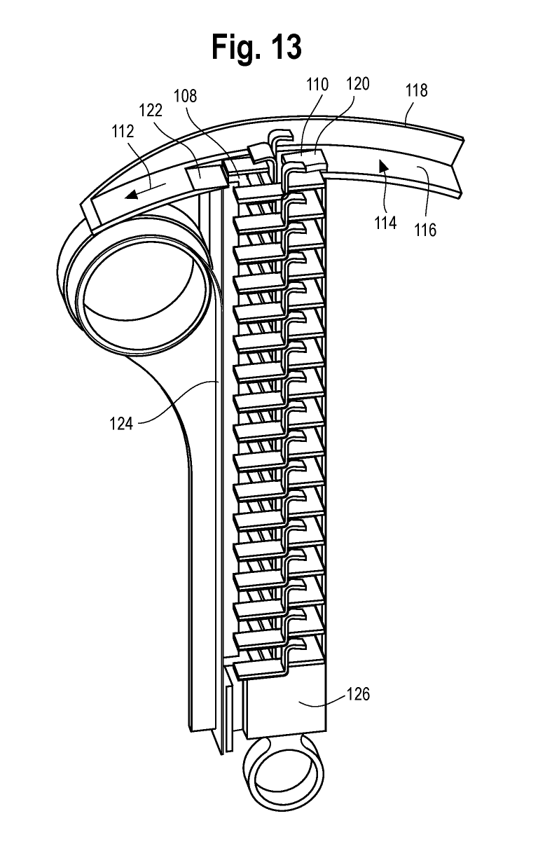

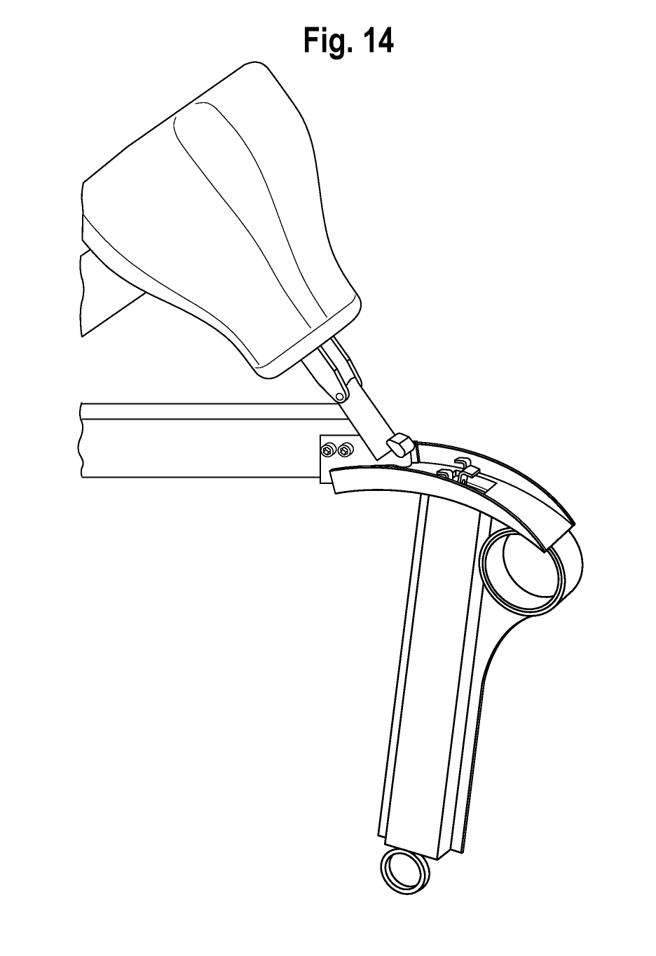

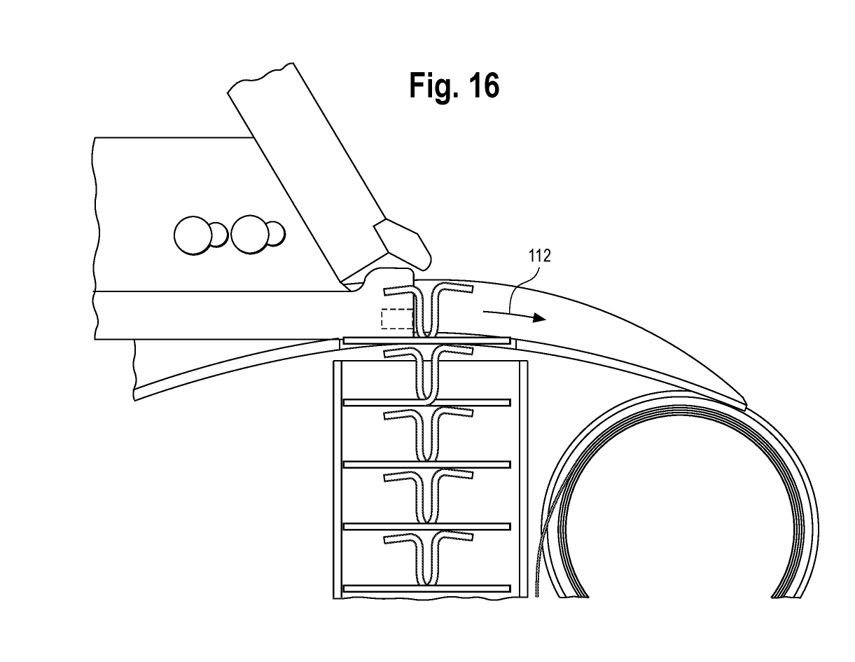

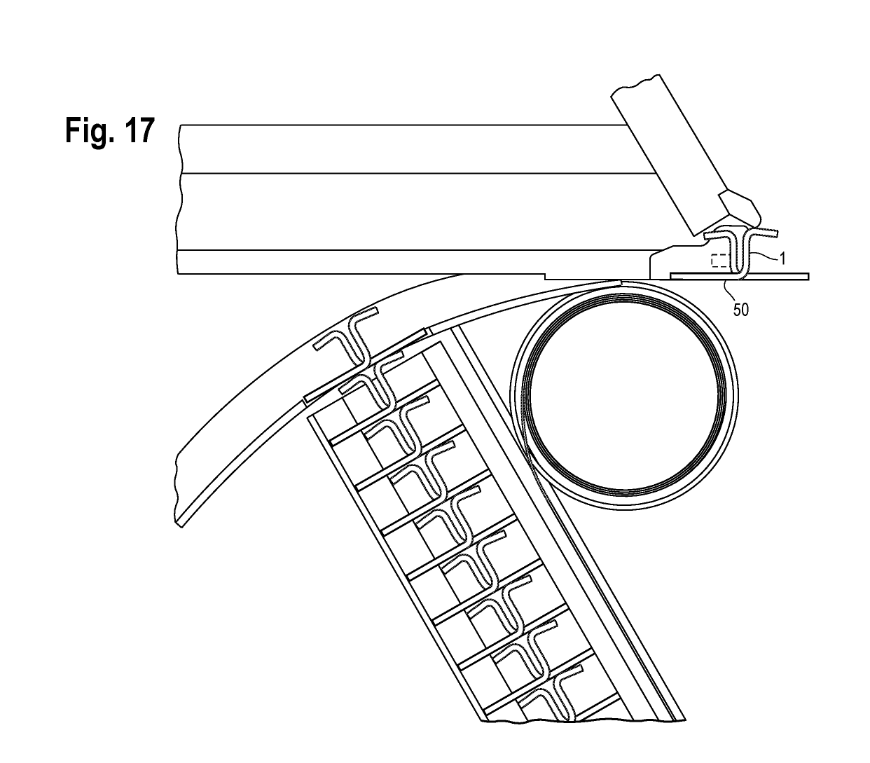

In an effort to further increase the efficiency of decking installers, a deck clip loader 102 can be used to load clips 1 onto the attachment 50. An embodiment of a loader 102 is illustrated in FIGS. 11-17. The loader 102 includes a magazine or sleeve 104 in which a plurality of stacked clips 1 are stored. The magazine 104 is configured so that clips 1 are removed from one end, a discharge end 106 (as they are positioned on the attachment 50) and clips 1 in the magazine 104 are indexed upwardly, toward the discharge end 106. The discharge end 106 includes an opening 108 sized so that the clips 1 are readily removed from the loader 102. As seen in FIGS. 13-14, a restraining finger 110 that extends away from and transverse to the opening 108 can be positioned spaced from and above the opening 108 to prevent the clips 1 from being ejected directly from the magazine opening 108. The finger 110 cooperates with the clips 1 to restrain the clips 1 at the opening 108, and so that the clips 1 are removed from the magazine 104 by moving the clips 1 transverse to the opening 108 (as indicated by the arrow at 112, transverse to the direction of clips 1 indexing through the magazine 104).

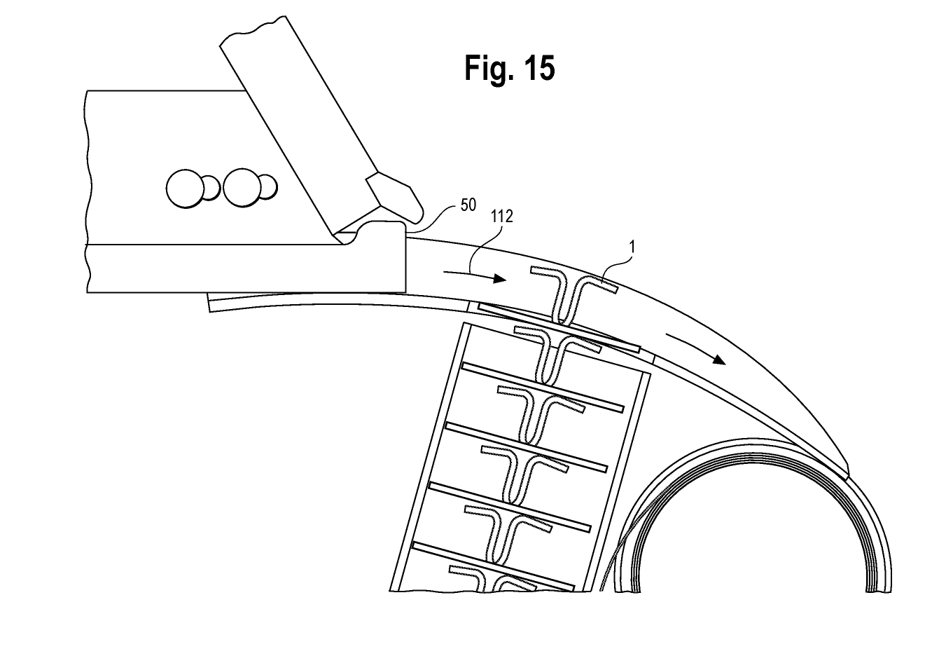

An embodiment of the loader 102 can include a slide 114 having a base surface 116 and a pair of guide walls 118. As will be appreciated from FIG. 15, the guide walls 118 can be spaced from one another so that the tool attachment 50 fits snuggly but easily between the walls 118 so that the loader 102 can be positioned on the attachment 50 and moved (slid) across the attachment 50 to position the clip 1 on the attachment 50. The slide 114 can include entrance and exit ramps 120, 122, respectively, at either side of the opening 108 so that the clips are readily fitted onto the attachment 50. In an embodiment, the restraining finger 110 forms the entrance ramp 120. As can be seen from FIG. 14 the restraining finger 110 cooperates with the rearward base flange 4 to restrain the clips 1 in the loader 102 until the clip 1 that is in the loading position in the loader 102 is “slid” onto the attachment 50.

In order to index the clips 1 in the loader 102, the loader 102 includes a biasing element 124, such as a spring, for example, a constant force spring, to urge the clips 1 toward the opening 108. In an embodiment, a plunger 126 is mounted to an end of the spring 124 and is positioned in an opening 128 at a bottom end 130 of the loader 102, opposite the loading opening 108. The plunger 126 applies a force to the clips 1 to urge the clips 1 toward the opening 108 and to urge the feed clip (the clip at the opening 108) into engagement with the restraining finger 110. The plunger 128 applies the force evenly across the clips 1 to prevent the clips 1 from skewing in the magazine 104. A grip 132, such as the illustrated ring, can be positioned on the plunger 126, opposite the clips 1 to facilitate pulling the plunger 126 from the magazine 104, to readily load and/or reload the magazine 104 with clips 1. The plunger 126 can be affixed or mounted to the spring 124 by a flange 134 having a connecting wall 136 that extends through a slot 138 in the magazine 104.

A user merely swings the loader 102 along the nosepiece N and the attachment 50 automatically engages and accepts the clip. The shape of the slide 114 is a natural complement to the swing of the loader 102, and the guide walls 118 maintain the loader 102 and attachment 50 aligned so that the clip 1 readily positions on the attachment 50. The geometry of the clip 1, along with the magnets 68 maintain the clip 1 on the attachment through the loader 102 “swing” and as the tool D is moved to the deck board B.

Those skilled in the art will appreciate the ease with which the attachment 50 allows a hidden deck clip 1 to be temporarily held or secured on a driver tool D for decking installations and the release of the clip 1 during fastener (e.g., screw) driving. It will also be appreciated that a loader 102 can be used to securely store multiple clips 1 for ready positioning on the attachment 50.

In the present disclosure, the words “a” or “an” are to be taken to include both the singular and the plural. Conversely, any reference to plural items shall, where appropriate, include the singular. All patents and published applications referred to herein are incorporated by reference in their entirety, whether or not specifically done so within the text of this disclosure.

It will also be appreciated by those skilled in the art that the relative directional terms such as sides, upper, lower, top, bottom, rearward, forward and the like are for explanatory purposes only and are not intended to limit the scope of the disclosure.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. An attachment for a drive tool for securing hidden deck clips in a substrate, the clips each having a body that is slit and bent to form a pair of forward base flanges and a rearward base flange and a forward groove flange formed from an upturned leg and groove leg between, above and spaced from the forward base flanges, the hidden deck clip including an opening between the rearward base flange and the forward groove flanges for receipt of a fastener to secure the hidden deck clip to the substrate, the attachment comprising:
a body;
a pair of legs defining a receiving region between the legs and between the substrate and body, the body including a top surface and a clip abutment surface; and
at least one magnetic element on the abutment surface for temporarily securing the hidden deck clip to the body.

2. The attachment of 1 wherein the at least one magnet is disposed in a bore in the body and wherein an end of the magnet lies about flush with the abutment surface.

3. The attachment of claim 1 including two magnets on the abutment surface.

4. The attachment of claim 3 wherein the magnets are disposed in bores in the body and wherein ends of the magnet lie about flush with the abutment surface.

5. The attachment of claim 1 wherein the legs extend above and below the body and forward of the clip abutment surface to center the clip on the attachment.

6. The attachment of claim 1 including a mounting region for mounting the attachment to the drive tool.

7. A clip loader for loading hidden deck clips to a tool attachment, comprising:
a clip magazine configured to store a plurality of clips, the clip magazine defining a discharge end opening from which clips are discharged to the tool attachment and a loading end opposite the discharge end;
a restraining finger extending over and spaced from a portion of the discharge end opening; and
a biased plunger to engage the plurality of clips and bias the plurality of clips toward the discharge end opening.

8. The loader of claim 7 wherein the plunger is biased by a spring.

9. The loader of claim 8 wherein the spring is a constant force spring.

10. The loader of claim 7 including a slide having a base surface and a pair of guide walls, the slide positioned at the discharge end of the magazine and having an opening therein cooperating with the magazine discharge end opening.

11. The loader of claim 10 including entrance and exit ramps at either side of the opening.

12. The loader of claim 11, wherein the restraining finger forms the entrance ramp.
